(19) United States
(12) Patent Application Publication
(10) Pub. No.: US 2017/0270279 A1
(43) Pub. Date: Sep. 21, 2017

(54) METHOD AND SYSTEM FOR IMPROVING SITE ACTIVATION THROUGH CRITICAL PATH MANAGEMENT AND IMPROVING PATIENT ENROLLMENT THROUGH FOCUSED SITE MANAGEMENT

(71) Applicant: Gen Li, East Lyme, CT (US)

(72) Inventor: Gen Li, East Lyme, CT (US)

(21) Appl. No.: 15/457,061

(22) Filed: Mar. 13, 2017

Related U.S. Application Data
(60) Provisional application No. 62/308,544, filed on Mar. 15, 2016.

(51) Int. Cl. G06F 19/00

(52) U.S. Cl. CPC G06F 19/363

(57) ABSTRACT

The present invention discloses methods for improving clinical trial planning and clinical trial operations deliverables. Specially, this invention introduces methods on shortening enrollment cycle time and/or improving more effective utilization of resources through critical path management in site activation and improvement of patient enrollment in focused site management.

### FIELD OF THE INVENTION

This invention relates to methods and systems for improving site activation and patient enrollment for clinical trial.

### BACKGROUND OF THE INVENTION

In the field of clinical trials, there are various definitions of operations management. Efficiency and effectiveness is the core feature of these definitions. There is no exception for operations management in the setting of clinical/medical development. Although there are relatively simple ways to measure the efficiency of clinical development operations management, such as shortened enrollment cycle time, reduced costs to implement a particular clinical trial, and etc., quantitative ways and means are not available. It is highly challenging to use such method for reaching the desired results. The challenges are further intensified by the fact that no clinical trials can be the same as another. It becomes tricky, therefore, to compare one clinical trial to another, in meaningful operations management terms.

Some companies such as Pharmaceutical Pipeline Enhancement Strategies LLC work in the field aiming to improve the situation. Their objectives include: providing a platform where objective expectations can be placed to operational deliverables; providing actionable recommendations to improve operational deliverables, and holding specific functional groups in the organization to be accountable to deliver those improved operational results.

Over the years, the research group of Pharmaceutical Pipeline Enhancement Strategies LLC has published a series of articles and patents including U.S. Pat. No. 8,271,296 aimed at building a conceptual framework and providing a better understanding on the relationships among factors and activities relating to clinical trials planning and execution.

Site Effectiveness Index (SEI), first introduced in U.S. Pat. No. 8,271,296, is used to measure the effectiveness of site activation process (EQUATION 1):

$$EQUATION 1 \text{:} Site Effectiveness ( SEI )$$

$$Mathematically , SEI can be defined as \text{:}$$

$$SEI = \frac{{\int }_{i = 1}^{N} ( {Et}_{i} - {St}_{i} )}{( {Et}_{s} - {St}_{i} ) \times N}$$

$$Where \text{:}$$

$$Eti \text{:} The time ( date ) site i closed for patient enrollment$$

$$Sti \text{:} The time ( date ) site i opened for patient enrollment$$

$$N \text{:} maximum number of sites opened for enrollment in the duration of patient enrollment at the study level$$

$$Ets \text{:} The time ( date ) clinical study ( trial ) closed for patient enrollment$$

$$Sts \text{:} The time ( date ) clinical study ( trial ) opened for patient enrollment$$

Clearly, the utilization of enrollment potential of all the sites being deployed in a clinical trial, as being measured by SEI, is determined by maximizing the duration of enrollment period by each and every participating site (Eti−Sti).

According to EQUATION 1, the true patient enrollment rate for an investigator site in a clinical trial is not determined by the enrollment cycle time of that clinical trial, rather, it is determined by the enrollment cycle time of that particular site. Collectively, when number of N sites is deployed for a trial, the trial level enrollment rate, as being defined by Average Site Enrollment Rate (ASER), is not determined by trial level enrollment cycle time (Ets−Sts), but is determined by the collection of individual site enrollment cycle times (Sum of (Eti−Sti)), as shown in EQUATION 2.

Based on the quantitative understanding, the best site selection method has been developed by far, which can provide site candidates to clients of clinical trials with consistently superior enrollment results. Clinical trial mathematical models are also built for feasibility assessment, which not only can accurately and dynamically plan critical clinical trial parameters, and forecast important operational deliverables, but also can provide actionable recommendations to improve operational deliverables.

$$EQUATION 2 \text{:} Average Site Enrollment Rate ( ASER )$$

$$\begin{matrix}To measure collective performance for a grou p of sites selected to \\ participate a clinical trial , we can use Average Sit e Enrollment \\ Rate ( ASER ) \text{:} \end{matrix}$$

$$ASER = \frac{TE}{{\int }_{i = 1}^{N} ( {Et}_{i} - {St}_{i} )}$$

$$\begin{matrix}Wherein TE is Total Enrollment \text{:} When it is in the planning stage , TE is \\ targeted patient enrollment . When historical data are being evaluated , \\ TE is the actual number of patient enrolled in a clinical trial . \end{matrix}$$

However, a plan cannot be static. One military philosopher stated that “a plan will be abolished when the first shot is fired”. So it would be highly important to update the plan and modify it to reflect the reality in the process of clinical trial execution.

Moreover, while actions in place are always recommend improving deliverables, those improved deliverables will never come to reality unless conscious and orchestrated efforts/actions are being taken by individual clinical trial teams.

### SUMMARY OF THE INVENTION

The present invention discloses methods and systems for improving clinical trial planning and clinical trial operations deliverables. Specially, this invention introduces methods on shortening enrollment cycle time and/or improving more effective utilization of resources through critical path management in site activation and improvement of patient enrollment in focused site management. In one aspect, the invention can identify the critical paths for efficiently reducing the cycle time. In one embodiment, the invention provides efficient tool for wisely screening proper sites for clinical trials. In another embodiment, the invention provides powerful tool for optimizing clinical trials at various levels such as site level, individual clinical trial level, clinical development program level, therapeutic level, and portfolio level. In another embodiment, the invention discloses methods for dynamically monitoring and optimizing the focused site management. In another embodiment, the invention discloses methods for wisely allocating resources for maximizing the performance of clinical trials.

### BRIEF DESCRIPTION OF THE DRAWINGS

FIG. 1: Illustrative Site Activation Critical Path

FIG. 2: Illustrative Focused Site Management

### DETAILED DESCRIPTION OF THE INVENTION

In one embodiment, this invention introduces methods on shortening enrollment cycle time and/or improving more effective utilization of resources through critical path management in site activation and improvement of patient enrollment in focused site management.

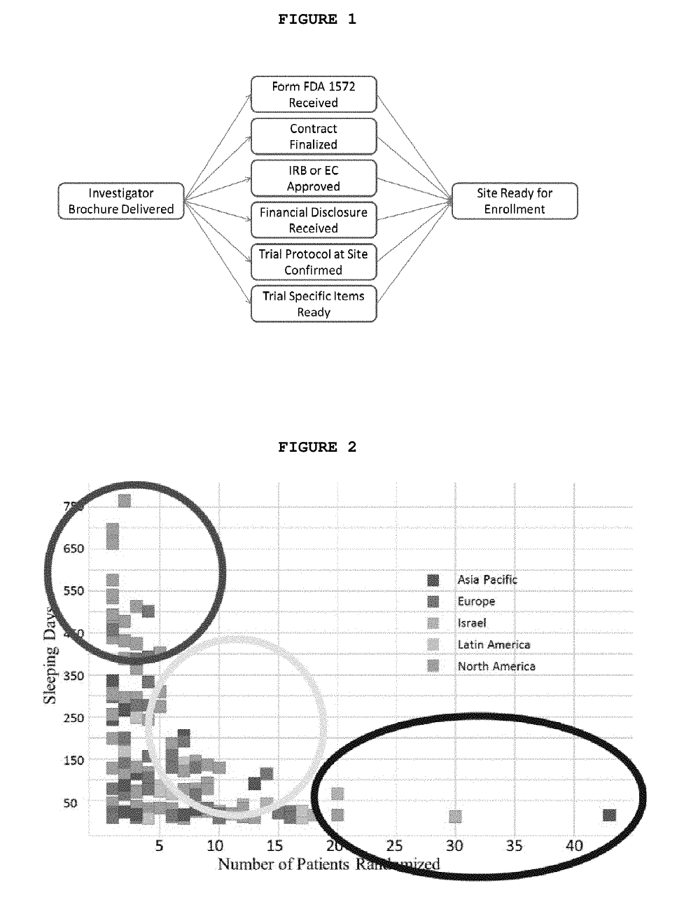

In one aspect, the invention discloses methods to improve Site Effectiveness Index by shortening critical path on individual site activation. When it starts to execute a clinical trial, resources are deployed (say, 20 sites per Full Time Employee Equivalent, FTEs), and “investigator brochure” is sent to each investigator site. As shown in FIG. 1, the investigator brochure contains, but is not limited to,
Clinical trial protocol
Form FDA 1572
Financial disclosure statement
Drafted contract
Request for IRB (Institutional Review Board) approval
Specific hardware and software required by the trial

Most of these require a lot of work, and each and every one of these has to be finished before the investigator sites can get the “green light” to enroll patients. It can be imagined that when the trial involves hundreds of sites and dozens of people working on the process, the professionals are overwhelmed by the workload, but may not make the right impact at the right time.

As a general principle in operations of management, only activities impacting critical path are effective to shorten cycle time.

Referring to Table 1, each row represents a country involved in trial or trials, while column represents activities in site activation process. The values in the table represent percentage of a particular activity to the whole trial. The particular activity with the longest duration is considered to be the critical path. This analysis can be conducted company wide. Those with highest percentages visualize opportunities for improvement. In this case, it would be recommended to discuss with the department responsible for contract management. IRB approval, handled by investigator sites, takes the highest time for the site activation, and specific actions can be taken to improve it. Another important conclusion from this particular table is that some of sites may not be suitable for activation based on the critical path analysis. For example, investigators in Australia simply do not understand the meaning of “Financial Disclosure” which is required by American law. So the Australian sites may not be activated because of that delay.

TABLE 1
Illustrative Site Activation Critical Path Analysis

| | Form | | | | | |
|---|---|---|---|---|---|---|
| | FDA | | Financial | IRB | Trial | Trial |
| Country | 1572 | Contract | Disclosure | or EC | Specific | Protocol |
| Australia | 7% | 26% | 59% | | 4% | |
| Canada | 20% | 55% | 10% | 10% | | |
| Netherlands | 19% | 15% | 8% | 38% | 19% | |
| Spain | | 19% | 8% | 27% | 4% | 38% |
| Sweden | 8% | 56% | 16% | | 16% | 4% |
| United | 6% | 33% | 12% | 48% | | |
| Kingdom | | | | | | |
| United States | 5% | 35% | 7% | 41% | 2% | 5% |
| Overall | 6% | 35% | 9% | 37% | 3% | 6% |

At the level of clinical trial, CRAs are managing this data in a dynamic fashion. A trial is initiated by CRAs with basic understanding about companywide data pattern, so that activities from all stakeholders are coordinated to minimize any possible hit of activities to critical path. CRAs are conscious about how the time can be used to reduce cycle time, not just to “get things done”.

Referring to EQUATION 1, every day reducing critical path will result in a day decreased in Sti. This will collectively increase the value in the sum of (Eti−Sti), which can increase the value of SEI. In parallel, when all the sites are activated earlier, and assuming other factors remain constant, the clinical trial will complete enrollment earlier accordingly, resulting in decreased Ets, therefore increase the value of SEI as well.

In one embodiment, the following are the steps to improve SEI through critical path management:
Define all the activities with the potential to be on the critical path leading to a site to be activated. There could be trial specific activities like some trials require having laboratory elements. But generally speaking these are quite consistent across the board.
Collect starting time (date) and completing time (date) for each of those defined activities at investigator site level.
Select the longest duration of time between that starting date and completing date for all the activities happening in parallel at investigator site level. This particular activity with the longest duration of time becomes the activity on the critical path in the site activation process for this particular investigator site.
Critical path analysis can be conducted at individual clinical trial level, clinical development program level, therapeutic level, and portfolio level.
At portfolio level, as shown in Table 1, all the data at trial level can be analyzed, and the percentage of times of a particular activity is calculated. This critical path analysis can identify key areas for improvement, such as obtaining IRB or EC approval, which takes longest time (37% of the time to get the approval) among all the site activation activities), and finalizing contract with investigator sites, which takes the second longest time (35% of the time). Both identified areas are the critical path for the improvement.
In the example of getting contract finalized with investigator sites, a specific functional group in the organization, i.e., the contract department, can take specific action(s) to reduce the percentage of times when finalizing a contract with an investigator site on the critical path. In return, the reduction of time for critical path will improve SEI cross the entire portfolio.
Similarly, critical path analysis can be performed at the clinical development level and at therapeutic area level to identify opportunities for improvement at the program level and at the therapeutically area level. Anything as unique to a specific development program and therapeutic area level can be used to improve SEIs in that level accordingly.
Monitoring and analysis of critical path at clinical trial level are more dynamic and more real time in nature. The value of trial level critical path analysis can be realized by comparing the results to the analysis at levels of program, therapeutic area, and portfolio to help identify issues unique to this specific clinical trial. It is usually required to take immediate actions in a timely fashion in order to improve Site Effective Index (SEI) for that particular clinical trial.

In another aspect, the invention also provides methods to improve patient enrollment through focused site management. Once sites are activated, there are usually dozens and sometime over 1,000 sites participating in a trial. It would be highly challenging to wisely perform clinical trials with the sites to enroll the patients as planned.

Not all sites are equal. Some of the sites will enroll more patients and some other sites can only enroll less. There are usually a percentage of sites which will never enroll any patients. A reliable method has been developed to help the clinical trial to pick more sites which have high enrollers, and to minimize the number of non-performing sites. Nevertheless, the targeted work on relevant sites can usually further improve collective site enrollment performance and shorten enrollment cycle time.

In one embodiment, as shown in the FIG. 2, each dot represents a single investigator site. The x-axis represents number of patient randomized (it can also be the number of patient screened, or number of patient enrolled if it is not a randomized trial), and the y-axis represents the number of days passed since the last patient was randomized.
The sites in the blue circle (on the bottom right of the chart) have a randomized large number of patients, and they randomized patients in high frequency. Generally, these sites know what they are doing and need little guidance. Moreover, it can be learned from these sites, which can cross fertilize to all sites to improve overall performance.
The sites in the red circle (in the top left corner of the chart) are “dead sites”. They only randomized one or two patients and long period of time has lapsed since then. It is unlikely these sites will contribute anything in the future. However, it still costs $1500 a month to maintain a site regardless their actual contribution. So these sites should be deleted from the trial.
Resource and attention should be more allocated on the sites in the yellow circle (on the bottom left). These sites contribute relatively significantly by enrolling large number of patients with less sleeping days. If these sites have slowed down for some reason, it is important for CRAs to understand their issues and solve the problems whenever possible.

The focused site management as shown in FIG. 2 is a dynamic process, which should be monitored on a daily basis. The focused site management should also cover from the first day the site open to enrollment to the last day a needed patient is randomized.

Referring to EQUATION 2, assuming all the other factors remain the same, instead of allocating the ⅓ of available resources to manage each of all the three categories of sites as described in FIG. 2, it is more wisely to allocate the ⅙ of resources for the sites in the red circle, the ⅙ of resources for sites in the blue circle, and the rest of the ⅔ of resources for sites in the yellow circle. This reallocation of resources will impact little or nothing to the enrollment results for sites in the blue or red circle. For the sites in the yellow circle, it is a different story. The allocation of extra resources usually leads to a significant increase of enrollment. In another word, the Total Enrollment (TE) in a defined period is increased, resulting in increased Average Site Enrollment Rate (ASER) for the clinical trial.

In one embodiment, the invention takes the following steps to improve patient enrollment through focused site management:
Pre-defining some of the parameters relevant to the method:
   Number of specific “Sleeping Days” when the level of resource support is lowered, or even the investigator sites may be forced to close, and those specific parameters in contract with the sites are also included.
   Number of Sleeping Days” when a site requires increased level of support.
Utilizing patient randomization data as being automatically generated by a specific patient randomization system, in case it is a randomized clinical trial. Patient enrollment data including the following fields can be utilized:
   Specific date of a patient if randomized.
   The affiliation of that patient with a specific investigator site (regions being colored differently in FIG. 2, for example).
   Other fields can be added, in order to enhance visualization, or add extra value to the visualization.
   Calculate total number of patients randomized in each investigator site, and use this as the value for the X axis.
   Calculate the number of days between the date last patient randomized, and the date of today, and use this as the value for Y axis.
   Depict the chart as shown in FIG. 2.
Patient screening data instead of the patient randomization data should be also used. In case of not randomized trial, patient enrollment data work fine as well.
This visualization, as shown in FIG. 2 as an example, should be shared among all of the trial team members in real time, to facilitate discussion among them in order to make collective and objective decisions in the resource deployment.
Quantifiable impact from focused site management to patient enrollment can be obtained by GSER analysis as described in U.S. Ser. No. 14/818,438.

Site activation in executing clinical trials is complicated, resource intensive, and often stressful to people involved. Introducing critical path management in site activation helps everyone in the game to aim at the same ball constantly and consistently, which is to shorten the time span of the critical path in activating individual investigator site. The method and system disclosed in the invention can quantitatively measure the effectiveness of critical path management through the impact on Site Effectiveness Index (SEI).

Once activated, the sites will enter “cruising” stage, during which patient enrollment activities are monitored until the trial reaches the enrollment goal. Level of resources support is often reduced at “cruising” stage of the trial. However, anything is resembled according to the complex, hectic, and enrollment goal. Proactively engaging sites and supporting them to solve problems are critically important for successful execution of clinical trials. Prioritized site management by focusing on the sites in need to maximize enrollment potential for deployed investigator sites can maximize Average Site Enrollment Rate (ASER), and shorten enrollment cycle time while resources are maximally utilized.

In summary, a framework of concepts in this invention can be utilized to improve clinical trial planning and improve clinical trial operations deliverables.

In one embodiment, the present invention provides a method of improving site activation in a clinical trial having a plurality of clinical trial sites, comprising steps below:
a) defining a plurality of activities that affect site activation;
b) determining a completion time for completing each of said activities in each of the clinical trial sites; and
c) identifying an activity with the longest completion time, wherein resources need to be provided to promote completion of said identified activity so as to improve site activation.

In one embodiment, the plurality of activities for improving site activation include, but is not limited to, completion of one or more of clinical trial protocol, forms required for the clinical trial, financial disclosure statement, contracts required for the clinical trial, approval from institutional review board, hardware required for the clinical trial, and software required for the clinical trial.

In one embodiment, the present invention is further characterized by identifying a second activity with the second longest completion time, wherein resources are provided to promote completion of said second activity so as to improve site activation.

In one embodiment, the present invention is performed at individual clinical trial level, clinical development program level, therapeutic level, or portfolio level.

In one embodiment, the present invention discloses a method for improving site activation in a clinical trial having a plurality of clinical trial sites, comprising
a) defining a plurality of activities that affect site activation;
b) monitoring progress of completing each activity in each clinical trial site; and
c) identifying one or more clinical trial sites that have the slowest progress of completing one or more of the activities, wherein resources are directed to the identified one or more clinical trial sites to speed up completion of the identified activities, thereby improving site activation.

In one embodiment, the plurality of activities for optimizing the targeted trial site include, but is not limited to, completion of one or more of clinical trial protocol, forms required for the clinical trial, financial disclosure statement, contracts required for the clinical trial, approval from institutional review board, hardware required for the clinical trial, and software required for the clinical trial.

In one embodiment, the present invention is further characterized that the monitoring progress further is compared with historical completion durations for each activity, which are derived from analysis of historical data.

In one embodiment, the present invention provides a method for improving patient enrollment in a clinical trial having a plurality of clinical trial sites, comprising
a) for each clinical trial site in the clinical trial, determining a first date when the last patient in that site is randomized, screened, or enrolled, which can define a first sleeping days for each site; and
b) comparing the first sleeping days with one or more pre-determined sleeping days derived from analysis of historical data.

In one embodiment, the present invention is characterized that when the first sleeping days for a site is more than a pre-determined second sleeping days, it is recommended the resource support for the site be decreased or stopped so as to improve patient enrollment.

In one embodiment, the present invention is characterized when said first sleeping days for a site is less than the pre-determined second sleeping days, it is recommended the resource support for the site be increased so as to improve patient enrollment at the site.

In one embodiment, the present invention is further characterized that the historical data comprise numbers of patients randomized, screened, or enrolled at a site and a number of sleeping days for the same site.

What is claimed is:

1. A method for improving site activation in a clinical trial having a plurality of clinical trial sites, comprising
a) defining a plurality of activities that affect site activation;
b) determining a completion time for completing each of said activities in each of said clinical trial sites; and
c) identifying an activity with the longest completion time, wherein resources need to be provided to promote completion of said identified activity so as to improve site activation.

2. The method of claim 1, wherein said plurality of activities comprises (i) completing one or more of clinical trial protocol, forms required for said clinical trial, financial disclosure statement, and contracts required for said clinical trial; (ii) obtaining approval from institutional review board; and (iii) acquiring hardware or software required for said clinical trial.

3. The method of claim 1, further comprises identifying a second activity with the second longest completion time, wherein resources are provided to promote completion of said second activity so as to improve site activation.

4. The method of claim 1, wherein said method is performed at individual clinical trial level, clinical development program level, therapeutic level, or portfolio level.

5. A method for improving site activation in a clinical trial having a plurality of clinical trial sites, comprising
a) defining a plurality of activities that affect site activation;
b) monitoring progress of completing each of said activities in each of said clinical trial site; and
c) identifying one or more clinical trial sites that have the slowest progress of completing one or more of said activities, wherein resources are directed to said identified one or more clinical trial sites to speed up completion of said one or more activities, thereby improving site activation in said clinical trial.

6. The method of claim 5, wherein said plurality of activities comprises (i) completing one or more of clinical trial protocol, forms required for said clinical trial, financial disclosure statement, and contracts required for said clinical trial; (ii) obtaining approval from institutional review board; and (iii) acquiring hardware or software required for said clinical trial.

7. The method of claim 5, wherein said monitoring in (b) further comprises comparing with historical completion durations for each of said activities, said historical completion durations are derived from analysis of historical data.

8. A method for improving patient enrollment in a clinical trial having a plurality of clinical trial sites, comprising
a) for each clinical trial site in said clinical trial, determining a first date when the last patient in that site is randomized, screened, or enrolled at said site, thereby defining a first sleeping days for each of said sites; and
b) comparing said first sleeping days with one or more pre-determined second sleeping days derived from analysis of historical data,
wherein when said first sleeping days for a site is more than a pre-determined second sleeping days, support for said site is decreased or stopped so as to improve patient enrollment in said clinical trial,
wherein when said first sleeping days for a site is less than said pre-determined second sleeping days, support for said site is increased so as to improve patient enrollment at said site, thereby improving patient enrollment in said clinical trial.

9. The method of claim 8, wherein said historical data comprise numbers of patients randomized, screened, or enrolled at a site and a number of sleeping days for the same site.
